(19) United States
(12) Patent Application Publication
(10) Pub. No.: US 2009/0195645 A1
(43) Pub. Date: Aug. 6, 2009

(54) SYSTEM OF DISPLAYING AND CAPTURING IMAGES USING NON-PLANAR MIRRORS

(75) Inventors: Udayan Kanade, Pune (IN); Balaji Ganapathy, Pune (IN)

Correspondence Address: Cowsy J. Wadia, 776 Coronado Lane, Foster City, CA, 94404, US

(73) Assignee: I2IC CORPORATION, Foster City, CA (US)

(21) Appl. No.: 12/302,320

(22) PCT Filed: May 25, 2007
(86) PCT No.: PCT/IB07/51991

§ 371 Date: Nov. 25, 2008

(30) Foreign Application Priority Data
May 25, 2006 (IN) 798/MUM/2006

(51) Int. Cl. H04N 7/18

(52) U.S. Cl. 348/77; 348/E07.085

(57) ABSTRACT

A system of displaying and capturing images using non-planar mirrors is disclosed. An embodiment of the invention comprises a display (402), a non-planar partially silvered mirror (404) and a camera (406). The non-planar partially silvered mirror (404) is used to build a compact system to optically combine the display (402) and capture directions. The use of non-planar mirrors (404) makes the system compact compared to a prior art system.

The present application claims the benefit of and priority to Indian Provisional Patent Application No. 798/MUM/2006 entitled “A System of Displaying and Capturing Images Using Non-Planar Mirrors” filed on May 25, 2006.

### FIELD OF INVENTION

The present invention relates to compact electronics displays and camera system. More particularly the invention relates to a electronic display and camera system using a non-planar partial mirror.

### BACKGROUND

There is a need for a display device that displays and captures images simultaneously. Such devices can be used in eye to eye video conferencing terminals, where the user can look directly into the eyes of the image of the person he is conversing with. Another use of such a device is in broadcasting, where the display device that prompts the presenter with visual text of the broadcast, has to be integrated with the camera.

FIG. 1 illustrates the block diagram of a prior art system 100, known in the art as a “teleprompter”. The system consists of a display 102, a partially silvered plane mirror 104 and a camera 106. The partially silvered plane mirror 104 is placed making an angle with the display 102. The user 108 can see display 102 through the partially silvered mirror. The camera 106 captures the image of the user 108 while he is viewing the display 102. For this system to work with the camera 106 at approximately the same level as display 102, and the partially silvered plane mirror 104, the mirror 104 juts out from the display. This makes the system bulky.

### SUMMARY

A system of displaying and capturing images using non-planar mirrors is disclosed. An embodiment of the invention comprises a display, a non-planar partially silvered mirror and a camera. The non-planar partially silvered mirror is used to build a compact system to optically combine the display and capture directions. The use of non-planar mirrors makes the system compact compared to a prior art system.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of a prior art system, known in the art as a “teleprompter”.

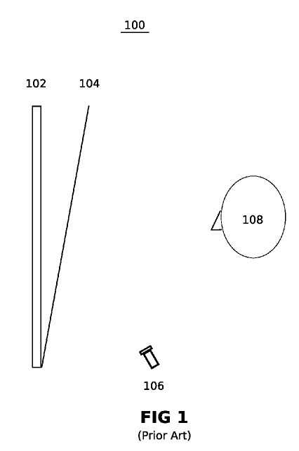

FIG. 2 illustrates a block diagram of an exemplary system of displaying and capturing images using non-planar mirror.

FIG. 3 illustrates a block diagram of an exemplary system of displaying and capturing images using non-planar mirror.

FIG. 4 illustrates a block diagram of an exemplary system of displaying and capturing images using non-planar mirror.

FIG. 5 illustrates a block diagram of an exemplary system of displaying and capturing images using non-planar mirror.

FIG. 6 illustrates a block diagram of an exemplary system of displaying and capturing images using non-planar mirror.

FIG. 7 illustrates a block diagram of an exemplary system of displaying and capturing images using non-planar mirror comprising an image correction system according to an embodiment of the present invention.

FIG. 8 illustrates a block diagram of an exemplary system of displaying and capturing images using non-planar mirror comprising an image correction system according to an embodiment of the present invention.

FIG. 9 illustrates a block diagram of an exemplary arrangement of pixels of the image capture device according to an embodiment of the present invention.

### DETAILED DESCRIPTION

A system of displaying and capturing images using non-planar mirrors is disclosed. An embodiment of the invention comprises a display, a non-planar partially silvered mirror and a camera. The non-planar partially silvered mirror is used to build a compact system to optically combine the display and capture directions. The use of non-planar mirrors makes the system compact compared to a prior art system. In an embodiment of the present invention, the image captured by the camera is corrected using an image correction system.

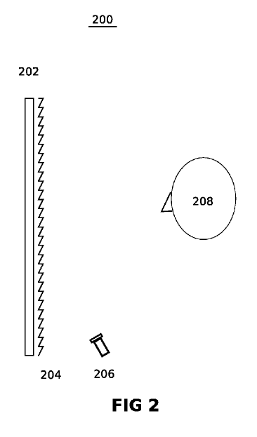

FIG. 2 illustrates a block diagram of an exemplary system of displaying and capturing images using non-planar mirror 200 according to an embodiment of the present invention. The system comprises a segmented mirror 204 placed directly in front of the display 202. The segmented mirror acts like a vertical mirror with a tilted normal surface. The camera 206 captures the image of the user 208 while the display 202 is visible from the location of the user 208. Since mirror 204 is segmented, it does not have to be tilted with respect to the display 202 and the system is more compact than a prior art system.

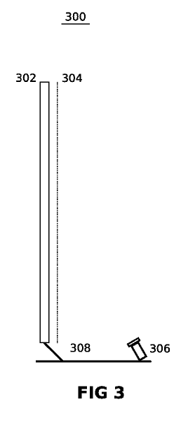

FIG. 3 illustrates a block diagram of an exemplary system of displaying and capturing images using non-planar mirror 300 according to an embodiment of the present invention. The system comprises a display 302, a partially silvered non-planar mirror 304, camera 306 and LCD stand 308. The camera 306 captures images of the user 310 while the display 302 is visible from the location of the user 310. Since mirror 304 is a non-planar mirror, the system is compact. The camera 306 is embedded in the stand 308 of the display.

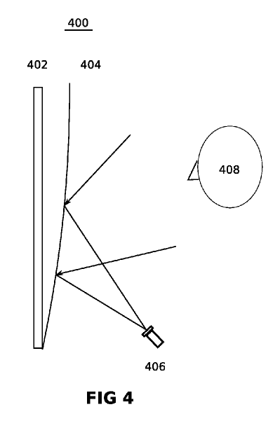

FIG. 4 illustrates a block diagram of an exemplary system of displaying and capturing images using non-planar mirror 400 according to an embodiment of the present invention. The system comprises a partially silvered non-planar mirror 404 placed directly in front of the display 402. The non-planar mirror 404 has a convex profile, i.e. it is a swept surface of a line and a convex curve. The camera 406 captures image of the user 408 while display 402 is visible from the location of the user 408. Since mirror 404 is a non-planar mirror which has a convex profile the system is more compact than the prior art system.

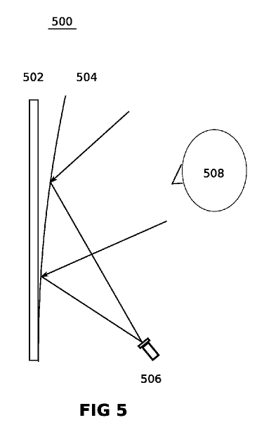

FIG. 5 illustrates a block diagram of an exemplary system of displaying and capturing images using non-planar mirror 500 according to an embodiment of the present invention. The system comprises a partially silvered non-planar mirror 504 placed directly in front of the display 502. The non-planar mirror 504 has a concave profile, i.e. it is a swept surface of a line and a concave curve. The camera 506 captures image of the user 508 while display 502 is visible from the location of the user 508. Since mirror 504 is a non-planar mirror which has a concave profile the system is more compact than the prior art system.

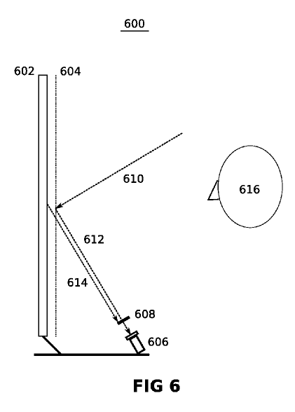

FIG. 6 illustrates a block diagram of an exemplary system of displaying and capturing images using non-planar mirror 600 according to an embodiment of the present invention. The system comprises a partially silvered non-planar mirror 604 placed directly in front of the display 602. The camera 606 is placed in a position from which the display is visible. Light 610 is unpolarized light reflected from the user 616. Light 612 is light 610 reflected from the mirror 604. Light 612 passes through the polarizer 608 which reduces it's intensity. This light enters camera 606 and image of the user is acquired. Light 614 emanated from display 602 is polarized. Hence a substantial part of light 614 is blocked by polarizer 608. This light 614 emanated by the display 602 does not interfere with light 612 and the acquisition of the image of user 616 by camera 606.

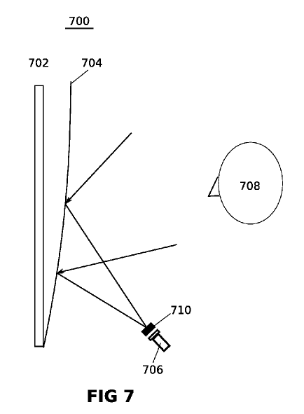

FIG. 7 illustrates a block diagram of an exemplary system of displaying and capturing images using non-planar mirror comprising an image correction system 700 according to an embodiment of the present invention. A partially silvered non-planar mirror 704 is placed in front of a display 702. The camera 706 captures image of the user 708 while display 702 is visible from the location of the user 708. An image correction system 710 is placed between the mirror 704 and camera 706. Image correction system 710 consists of optical components comprising mirrors and lenses. The correction system 710 is used to get the desired image at input of camera 706 and correct for abberations, if any. In an embodiment, the mirror 704 has a convex profile and a concave lens is used as the image correction system. In an embodiment, mirror has a concave profile and a convex lens is used as the image correction system. In an embodiment, a correction system is made by estimating the transfer function of the mirror and inverting it in the image correction system.

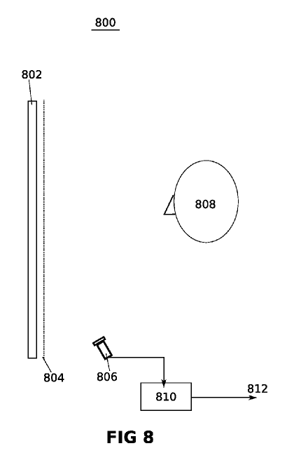

FIG. 8 illustrates a block diagram of an exemplary system of displaying and capturing images using non-planar mirror comprising an image correction system 800 according to an embodiment of the present invention. A partially silvered non-planar mirror 804 is placed in front of display 802. The camera 806 captures the image of the user 808 while display 802 is visible from the location of the user 808. The output of the camera is given to image correction system 810 comprising an image correction algorithm running on a computing device. The correction system 810 is used to get the desired image at the output 812 and correct for abberations, if any. For example, an image unwarping algorithm may be used to obtain the required image at output 812. In an embodiment, a correction system is made by estimating the transfer function of the mirror and inverting it in the image correction system.

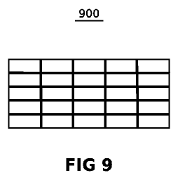

FIG. 9 illustrates a block diagram of an exemplary arrangement of pixels of the image capture device 900 according to an embodiment of the present invention. The image available at the camera 306 in FIG. 3 has a wider aspect ratio than the required image. For example, by arranging the pixels of image capture device to have a wide aspect ratio as shown, a correct image can be obtained. The image correction system is embedded in the layout of pixel and hence in the image capture device 900. In an embodiment, a correction system is made by estimating the transfer function of the mirror and inverting it in the image correction system. In an embodiment, pixels of different aspect ratios are placed at different locations in the image capture device.

A system of displaying and capturing images using non-planar mirrors and methods pertaining thereto are disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. An apparatus comprising
a video display,
a partially silvered non-planar mirror, and
a camera,
the said display, partially silvered non-planar mirror and camera being arranged so that the camera can capture image of a viewer viewing the display

2. The apparatus of claim 1, wherein the non-planar mirror is a segmented mirror.

3. The apparatus of claim 1, wherein the non-planar mirror is a swept surface of a line and a convex curve.

4. The apparatus of claim 1, wherein the non-planar mirror is a swept surface of a line and a concave curve.

5. The apparatus of claim 1, further comprising a polarizer placed in front of the camera.

6. The apparatus of claim 5, wherein the polarizer is placed so that it transmits negligible light emanating from the display.

7. The apparatus of claim 1, wherein the camera is embedded in the stand for the display.

8. The apparatus of claim 1, further comprising an image correction system.

9. The apparatus of claim 8, wherein the image correction system comprises an optical system.

10. The apparatus of claim 8, wherein the image correction system comprises an algorithm running on a computing device.

11. The apparatus of claim 8, wherein the image correction system comprises an arrangement and shape of pixels in the image capture device.
